(19) United States
(12) Patent Application Publication
(10) Pub. No.: US 2026/0321033 A1
(43) Pub. Date: Oct. 15, 2026

(54) METHOD FOR ESTIMATING LEFTOVER FEED IN TROUGHS OF BATTERY CAGE-RAISED LAYING HEN HOUSE AND APPARATUS

(71) Applicant: ZHEJIANG UNIVERSITY, Zhejiang (CN)

(72) Inventors: Hongjian LIN, Zhejiang (CN); Jinhui ZHANG, Zhejiang (CN); Pengguang HE, Zhejiang (CN); Yunxiao JIANG, Zhejiang (CN); Jinming PAN, Zhejiang (CN); Yibin YING, Zhejiang (CN)

(73) Assignee: ZHEJIANG UNIVERSITY, Zhejiang (CN)

(21) Appl. No.: 19/675,451

(22) Filed: May 12, 2026

Related U.S. Application Data
(63) Continuation of application No. PCT/CN2025/099784, filed on Jun. 7, 2025.

(30) Foreign Application Priority Data
Dec. 5, 2024 (CN) 202411777035.6

(51) Int. Cl. G06V 20/68; A01K 39/01; G06V 10/12; G06V 10/25; G06V 10/26; G06V 10/28; G06V 10/70; G06V 20/52

(52) U.S. Cl. CPC G06V 20/68; A01K 39/0106; G06V 10/12; G06V 10/25; G06V 10/26; G06V 10/70; G06V 20/52; G06V 10/28

(57) ABSTRACT

A method for estimating leftover feed in troughs of a battery cage-raised laying hen house and an apparatus are provided. The method includes constructing a leftover feed data collection system and collecting hen cage trough videos at different heights in the battery cage-raised hen house through the leftover feed data collection system; constructing a trough leftover feed prediction model, training the trough leftover feed prediction model using each frame of hen cage trough image, and obtaining a trained trough leftover feed prediction model after training is completed; inputting the hen cage trough videos into the trained trough leftover feed prediction model to obtain each cage column position and each leftover feed region position; and according to the cage column positions and the leftover feed region positions output by the trough leftover feed prediction model, obtaining a leftover feed proportion of each trough in the hen cage trough images.

### CROSS-REFERENCE TO RELATED APPLICATION

This application is a continuation of international application of PCT application serial no. PCT/CN2025/099784, filed on Jun. 7, 2025, which claims the priority benefits of China Application No. 202411777035.6, filed on Dec. 5, 2024. The entirety of each of the above-mentioned patent applications is hereby incorporated by reference herein and made a part of this specification.

### BACKGROUND

### Technical Field

The invention belongs to the field of poultry industry, and particularly relates to a method for estimating leftover feed in troughs of a battery cage-raised laying hen house and an apparatus.

### Description of Related Art

With the rapid development of the poultry industry, the scale of laying hen farming continues to expand, and traditional manual feeding methods can no longer meet the high efficiency and refined management requirements of modern farming. The battery cage raising model has developed rapidly in China and has become the mainstream of laying hen farming due to its advantages of high production efficiency, high space utilization, and stable egg supply. In the process of laying hen farming, feed management is a key link to ensure healthy growth and high egg production rate of chickens. However, the traditional feed delivery and management methods have many shortcomings. First, low efficiency of manual management: relying on manual periodic inspection and feed addition is time-consuming and labor-intensive, and it is difficult to achieve precise control. Second, feed waste problem: due to the lack of precise feed delivery and leftover feed amount monitoring, it often leads to excess or insufficient feed, and resources are thereby wasted. Third, health risks: unbalanced feed amounts may cause malnutrition or overeating in chickens, and chicken health and production performance may thus be affected. Fourth, difficult environmental control: leftover feed is prone to spoilage, so hen house hygiene is affected, and the risk of disease transmission grows.

### SUMMARY

To solve the problems in the background technology, the purpose of the invention is to provide a method for estimating leftover feed in troughs of a battery cage-raised laying hen house and an apparatus, in the method and the apparatus, accurate estimation of the remaining feed amount in the troughs of the laying hen house can be achieved, and through automation and intelligent technology, the invention can improve the efficiency and accuracy of feed management, reduce feed waste, and optimize the breeding environment for chickens, so that the production performance of laying hens and the economic benefits of breeding is enhanced.

The technical solution adopted by the invention is as follows, and the following steps are included.
In step S1, a leftover feed data collection system is constructed, and hen cage trough videos at different heights in a battery cage-raised hen house is collected through the leftover feed data collection system.
In step S2, a trough leftover feed prediction model for identifying cage columns, troughs, and the leftover feed in the troughs is constructed in a computer, the trough leftover feed prediction model is trained using the hen cage trough videos, and a trained trough leftover feed prediction model is obtained after training is completed.
In step S3, the hen cage trough videos with a leftover feed proportion to be predicted are input into the trained trough leftover feed prediction model, and each cage column position, each trough region position, and each leftover feed region position in the hen cage trough videos are obtained.
In step S4, according to the cage column positions, the trough region positions, and the leftover feed region positions output by the trough leftover feed prediction model, in the computer, a leftover feed proportion of each trough in the hen cage trough videos is obtained.

The step S1 specifically includes the following.
In step S1.1, the leftover feed data collection system is constructed in the battery cage-raised hen house first. The leftover feed data collection system mainly includes a mobile chassis, an adjustable camera bracket, and a camera. The mobile chassis is horizontally movably and is placed on the ground, the adjustable camera bracket is vertically installed on the mobile chassis, and the camera is movably installed on the adjustable camera bracket in an up-down direction.
In step S1.2, an angle and a position of the camera are adjusted in real time through the leftover feed data collection system, and the hen cage trough videos at different heights in the battery cage-raised hen house are collected in real time using the camera.

The step S2 specifically includes the following.
In step S2.1, the hen cage trough videos is preprocessed: first, image denoising, image contrast adjustment, and image size standardization are sequentially performed on each frame of hen cage trough picture in the hen cage trough videos, the cage columns around hen cages are labeled with cage column detection boxes by using a picture labeling tool to obtain position information of the cage columns, and the hen cage trough pictures are then labeled by using the picture labeling tool to label trough regions and leftover feed regions in the hen cage trough pictures.
In step S2.2, a hen cage trough leftover feed dataset is then constructed using each frame of hen cage trough picture and corresponding label information. The label information includes cage column position information, trough region information, and leftover feed region information in the hen cage trough pictures.
In step S2.3, the trough leftover feed prediction model for identifying the cage columns, the troughs, and the leftover feed regions are constructed, the trough leftover feed prediction model is trained using the hen cage trough leftover feed dataset, and the trained trough leftover feed prediction model is obtained after training is completed.

The step S4 specifically includes the following.
In step S4.1, first, according to input results of each frame of hen cage trough image in the hen cage trough videos, target cage columns in the hen cage trough videos are filtered out. The input results of each frame of hen cage trough image include the cage column positions, the trough region positions, and the leftover feed region positions output in step S3.
In step S4.2, next, according to target cage column positions, hen cages in the hen cage trough videos are numbered, and a target hen cage is selected from each frame of hen cage trough image.
In step S4.3, lastly, according to the target cage column position, a region of interest is defined within the target hen cage, and the leftover feed proportion of each hen cage trough is obtained according to the region of interest.

The step S4.1 specifically includes the following.
In step S4.1.1, first, according to the cage column positions output from step S3, processing is performed according to the following formula to obtain coordinates of each cage column center point Pⱼ in each hen cage trough image:

PXⱼ=xⱼ+wⱼ/2; PYⱼ=yⱼ+hⱼ/2,

where PXⱼ and PYⱼ are respectively the horizontal and vertical coordinates of a center point Pⱼ of a j^{th} cage column in the hen cage trough image, xⱼ and yⱼ are respectively the horizontal and vertical coordinates of a top-left corner vertex of a cage column detection box corresponding to the j^{th} cage column, wⱼ and hⱼ are respectively a width and a height of the cage column detection box corresponding to the j^{th} cage column, where j represents an ordinal number of the cage column.
In steps S4.1.2, next, according to a horizontal coordinate spacing between the center points of two adjacent cage columns, reasonableness of the cage column positions is determined to obtain the target cage columns with reasonable positions. The specific method of acquiring the target cage columns is as follows.
In step S4.1.2.1, first, a first cage column in the hen cage trough image is designated as a first target cage column.
In step S4.1.2.2, next, the number of filters Z is defined as 2.
In step S4.1.2.3, the reasonableness of a current Z^{th} cage column position is determined.

If the horizontal coordinate spacing between the center point of the current cage column and the center point of the previous target cage column is greater than a distance threshold Xₗᵢₘᵢₜ, it indicates that the current Z^{th} cage column is the target cage column, and the number of filters Z is incremented by 1.

Otherwise, it indicates that the current Z^{th} cage column is not the target cage column, and the number of filters Z is incremented by 1.
In step S4.1.2.4, step S4.1.2.3 is repeated until the position determination of all cage columns is completed.

The step S4.2 specifically includes the following.
In step S4.2.1, each hen cage in each hen cage trough video is numbered: in the hen cage trough video, each target cage column is numbered in an ascending order according to a timeline sequence, and a rectangular region between an i^{th} target cage column and an (i+1)^{th} target cage column in the hen cage trough video is then treated as an i^{th} hen cage CAᵢ of the hen cage trough video, where a height of the hen cage uses a given constant, and i represents an ordinal number of the target cage column/hen cage.

In step S4.2.2, target hen cages for leftover feed calculation are selected from each frame of hen cage trough image.

For any frame of hen cage trough image, if the horizontal coordinate of the center point of the hen cage CAᵢ is greater than Wp/3 and less than 2Wp/3, then the hen cage CAᵢ in that frame of hen cage trough image is the target hen cage, where Wp represents a width of the hen cage trough image.

Otherwise, the hen cage CAᵢ in the hen cage trough image of that frame is not the target hen cage.

The step S4.3 specifically includes the following.
In step S4.3.1, corner points of a region of interest ROI to be defined are determined according to the target cage column position. The region of interest ROI includes a rectangular upper region of interest UROI and a rectangular lower region of interest LROI, the four corner points and corner point coordinates of the upper region of interest are upper corner point one Urec1(Xᵢ,Yᵢ), upper corner point two Urec2(Xᵢ₊₁,Yᵢ), upper corner point three Urec3(Xᵢ,3Hp/5), and upper corner point four Urec4(Xᵢ₊₁,3Hp/5), the four corner points and corner point coordinates of the lower region of interest are lower corner point one Lrec1(Xᵢ,3Hp/5), lower corner point two Lrec2(Xᵢ₊₁,3Hp/5), lower corner point three Lrec3(Xᵢ,Hp) and lower corner point four Lrec4(Xᵢ₊₁,Hp).

Herein, Xᵢ and Yᵢ are respectively the horizontal coordinate and vertical coordinate of the center point of an i^{th} target cage column in the hen cage trough image, Xᵢ₊₁ is the horizontal coordinate of the center point of an (i+1)^{th} target cage column, and Hp represents a height of the hen cage trough image.
In step S4.3.2, according to the corner point coordinates of the upper region of interest and the lower region of interest, the target hen cage of each frame of hen cage trough image is divided into the upper region of interest and the lower region of interest. The target hen cage region of each frame of hen cage trough image includes two layers of troughs, and an upper trough and a lower trough are located within the upper region of interest and the lower region of interest respectively.
In step S4.3.3, in the hen cage trough image, segmentation masking is performed on the leftover feed region within the target hen cage region to obtain a binary image of the leftover feed region.
In step S4.3.4, processing is performed according to the following formula to obtain a leftover feed proportion of each of the upper trough and the lower trough of each target hen cage in each frame of hen cage trough image:

PrecisionU=MaskU/((Xᵢ₊₁−Xᵢ)(Uyu−Uyl))

PrecisionL=MaskL/((Xᵢ₊₁−Xᵢ)(Lyu−Lyl)),

where PrecisionU is the leftover feed proportion of the upper trough in the upper region of interest of the target hen cage, PrecisionL is the leftover feed proportion of the lower trough in the lower region of interest of the target hen cage, MaskU represents the number of white pixels in a binary image of an upper trough leftover feed region, MaskL represents the number of white pixels in a binary image of a lower trough leftover feed region, Uyu represents a vertical coordinate of an upper boundary line of the upper trough, Uyl represents a vertical coordinate of a lower boundary line of the upper trough, Lyu represents a vertical coordinate of an upper boundary line of the lower trough, and Lyl represents a vertical coordinate of a lower boundary line of the lower trough.
In step S4.3.5, for the same target hen cage with the same number in all hen cage trough images, all upper trough leftover feed proportions corresponding to the same target hen cage are averaged to obtain a final upper trough leftover feed proportion of the i^{th} hen cage CAᵢ in the hen cage trough video, and all lower trough leftover feed proportions corresponding to the same target hen cage are averaged to obtain a final lower trough leftover feed proportion of the i^{th} hen cage CAᵢ in the hen cage trough video.

An apparatus of the invention includes construction of the leftover feed data collection system, the trough leftover feed prediction model, and a leftover feed amount measuring system. The leftover feed data collection system including the mobile chassis, the adjustable camera bracket, and the camera is constructed. The mobile chassis is horizontally movably and is placed on the ground, the adjustable camera bracket is vertically installed on the mobile chassis, and the camera is movably installed on the adjustable camera bracket in an up-down direction. The mobile chassis and the adjustable camera bracket are configured to adjust a position and an angle of the camera. The camera is configured to collect in real time the hen cage trough videos at different heights in the battery cage-raised hen house and input the hen cage trough videos into the trained trough leftover feed prediction model. The trough leftover feed prediction model outputs the cage column positions, the trough positions, and the leftover feed region positions of various frames of hen cage trough videos in the hen cage trough videos. The leftover feed amount measuring system obtains the leftover feed proportions of the troughs in the frames of hen cage trough images according to the cage column positions, the trough positions, and the leftover feed region positions output by the trough leftover feed prediction model.

The invention aims to optimize feed management through automation technology and improve breeding efficiency and economic benefits. The apparatus is specially designed with the leftover feed data collection system and equipped with a high-definition camera and an adjustable bracket to adapt to troughs of different heights, so that comprehensive data collection is achieved. By precisely measuring the hen house environment and designing the corresponding bracket, the quality of image collection and data accuracy are ensured. The core of the trough leftover feed prediction model lies in model training and post-processing, which adopts deep learning frameworks and the Yolov8n-seg model to train the collected image data. Precise identification and segmentation of hen cage edges and leftover feed regions are thereby achieved. Additionally, through object tracking algorithms and continuous frame processing, the system is able to maintain stable tracking of cage columns and leftover feed, so that continuity and accuracy of cage-by-cage processing and leftover feed estimation are ensured. In the invention, feed leftover conditions are monitored in real time in actual laying hen houses, feeding strategies are adjusted, and data analysis reports are provided to assist breeding personnel in making scientific breeding decisions. The implementation of the invention not only reduces feed waste but also improves the breeding environment for chickens, contributing to the sustainable development of the breeding industry.

Beneficial effects provided by the invention include the following.
1. Feed management accuracy and efficiency improvement: In the invention, accurate estimation of leftover feed amount in troughs of a laying hen house is achieved through an automated leftover feed data collection system and deep learning model. Compared with traditional manual inspection, through this system, the accuracy and efficiency of feed management are significantly improved, and human errors and labor intensity are reduced. Automated monitoring and data analysis reduce dependence on extensive human resources while ensuring timely and appropriate feed distribution.
2. Chicken breeding environment optimization: Through real-time monitoring of feed distribution and leftover feed conditions, in the invention, problems of excessive or insufficient feed can be effectively avoided, feed waste is reduced, and the hen house hygiene is prevented from being affected by feed spoilage, so that the breeding environment for chickens is optimized. This not only helps improve the health level and production performance of laying hens, but also reduces the risk of disease transmission and enhances the overall sustainability of the breeding industry.
3. Intelligent decision support: The system of the invention is not limited to real-time monitoring and data reporting, but also provides intelligent decision support. The system may automatically remind breeding personnel according to the leftover feed amount, so that refined breeding management is achieved. This intelligent decision support mechanism makes breeding management more scientific and flexible and may adapt to the nutritional needs of laying hens at different growth stages, so that breeding efficiency and economic benefits are further improved.

### BRIEF DESCRIPTION OF THE DRAWINGS

FIG. 1 is a schematic view of a data collection platform system of the invention.

FIG. 2 is a schematic view of light source measurement points and lighting environment.

FIG. 3 is a model training result graph, where A is a bounding box loss graph of a training set, B is a segmentation loss graph of the training set, C is a classification loss graph of the training set, D is a depth loss graph of the training set, E is a bounding box loss graph of a test set, F is a segmentation loss graph of the test set, G is a classification loss graph of the test set, H is a depth loss graph of the test set, I is a precision graph of a bounding box, J is a recall graph of the bounding box, K is a mean average accuracy (threshold is 0.5) graph of the bounding box, L is a mean average accuracy (threshold is 0.5 to 0.95) graph of the bounding box, M is a precision graph of a mask, N is a recall graph of the mask, O is a mean average accuracy (threshold 0.5) graph of the mask, and P is a mean average accuracy (threshold is 0.5 to 0.95) graph of the mask.

FIG. 4 is a processing flow chart of system hen cage segmentation and leftover feed identification.

FIG. 5 is a processing flow chart of leftover feed identification of a single frame picture.

### DESCRIPTION OF THE EMBODIMENTS

The invention will be described in detail in the following paragraphs together with specific implementation cases. The following embodiments will help a person having ordinary skill in the art to further understand the invention, but do not limit the invention in any form.

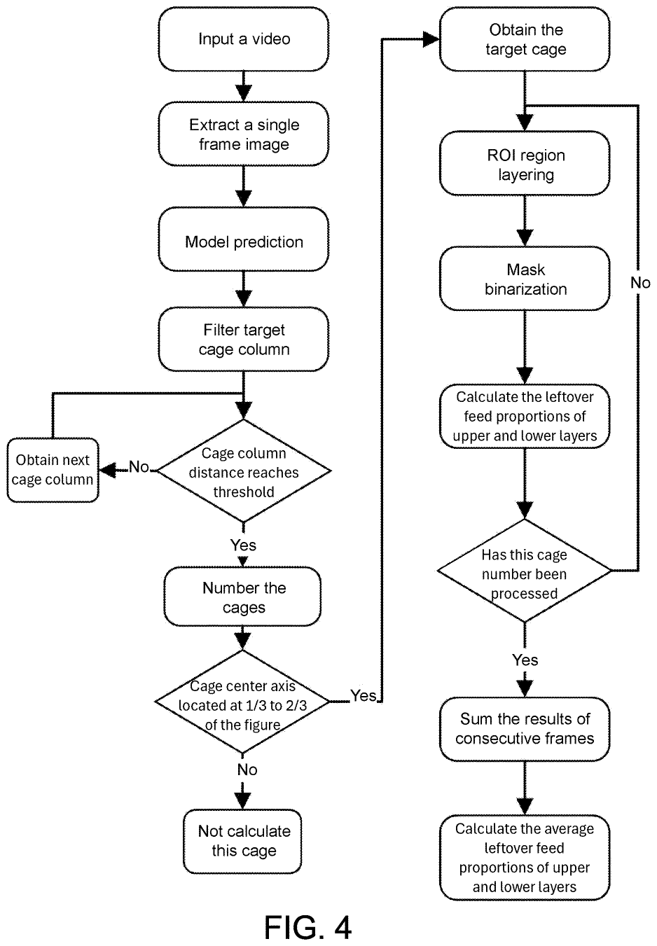

As shown in FIG. 4, the embodiments of the invention include the following steps.
In step S1, a leftover feed data collection system is constructed, and hen cage trough videos at different heights in a battery cage-raised hen house is collected through the leftover feed data collection system.
In step S2, a trough leftover feed prediction model for identifying cage columns, troughs, and the leftover feed in the troughs is constructed, the trough leftover feed prediction model is trained using the hen cage trough videos, and a trained trough leftover feed prediction model is obtained after training is completed.
In step S3, the hen cage trough videos with a leftover feed proportion to be predicted are input into the trained trough leftover feed prediction model, and each cage column position, each trough region position, and each leftover feed region position in each frame of hen cage trough images in the hen cage trough videos are obtained. Each frame of hen cage trough image contains two-layer troughs and two-layer trough cage columns.
In step S4, according to the cage column positions, the trough region positions, and the leftover feed region positions output by the trough leftover feed prediction model, a leftover feed amount measuring system obtains a leftover feed proportion of each trough in the hen cage trough videos.

Application of an estimation system: the trained prediction model is deployed to an actual laying hen house trough monitoring system. The system may monitor the feed distribution and leftover feed situation in real time, automatically adjust the feed distribution strategy, and ensure that laying hens receive appropriate nutritional supply. Meanwhile, the system may also provide data analysis reports to the breeding personnel and assists them in making more scientific breeding decisions.

Model deployment: The trained model is deployed to an inspection system of the actual laying hen house, and the system includes a high-definition camera, a data processing unit, a control unit, and a user interface. Real-time monitoring: The system captures images of troughs in real time through the high-definition camera, utilizes the deployed model to analyze the images, and monitors feed distribution and leftover feed conditions in real time. Data analysis reporting: The system generates data analysis reports, including feed consumption trends for each hen cage, leftover feed amount prediction, and nutritional intake assessment, so scientific decision-making basis is provided for the breeding personnel. User interface interaction: Through the user interface, the breeding personnel may view the feed monitoring data and analysis reports in real time, perform manual adjustment, or confirm system adjustment recommendation. Intelligent decision support: The system provides intelligent decision support, such as automatically reminding the breeding personnel when leftover feed amount falls below a predetermined threshold or automatically adjusting the feed formulation under specific conditions. System performance: The deployed model and the system design consider compatibility with the existing breeding equipment, so that seamless integration into laying hen houses of various scales is ensured. The system design exhibits good scalability and is capable of flexibly adding monitoring points or adjusting system configuration according to the expansion or changes in breeding scale. The system considers lighting condition variations in different breeding environments, so that stable operation under various environmental conditions is ensured through algorithm optimization.

Step S1 specifically includes the following.
In step S1.1, the leftover feed data collection system is constructed in the battery cage-raised hen house first. The leftover feed data collection system mainly includes a mobile chassis, an adjustable camera bracket, and a camera. The mobile chassis is horizontally movably and is placed on the ground, the adjustable camera bracket is vertically installed on the mobile chassis, and the camera is movably installed on the adjustable camera bracket in an up-down direction.
In step S1.2, an angle and a position of the camera are adjusted in real time through the leftover feed data collection system, and the hen cage trough videos at different heights in the battery cage-raised hen house are collected in real time using the camera.

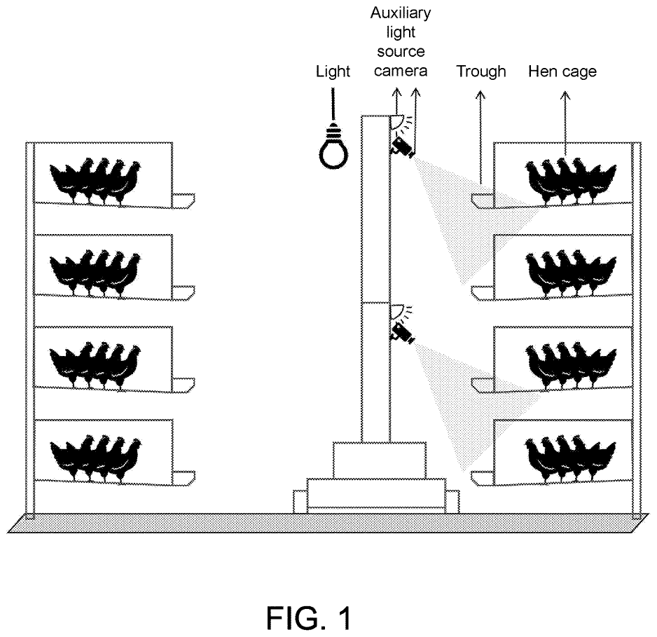

In specific implementation, the leftover feed data collection system is shown in FIG. 1. The leftover feed data collection system mainly consists of the mobile chassis, a plurality of adjustable camera brackets, and cameras to adapt to troughs at different heights in the battery cage-raised hen house, so that flexibility and adaptability are ensured. Key data such as hen house aisle gaps, light installation positions, inter-cage distances, and hen cage heights may be accurately obtained by using measuring tools such as tape measures. One adjustable camera bracket has a height exceeding two layers of hen cages, so as to collect leftover feed data from the first and second-layer troughs. Another adjustable camera bracket may raise the camera to a height exceeding four layers of hen cages through motor control, so collection of leftover feed data from the third and fourth-layer troughs is implemented. Through this design, the leftover feed data collection system of the invention may cover troughs at all layers, and a comprehensive and efficient solution for leftover feed estimation is thus provided.

The installation method of the camera is as follows. First, according to the height of the hen cage, the camera adjustable bracket is manually adjusted to an appropriate height to adapt to troughs at different layers. The high-precision camera is installed onto the camera adjustable bracket and is connected to a control computer using a data cable to ensure the stability and real-time performance of data transmission. The camera's preview function is utilized to carefully adjust the installation angle and height of the camera. During the adjustment process of camera angle and height, it is ensured that the trough in the image remains horizontal and parallel to the long axis of the image, so as to improve the accuracy and efficiency of image processing. The camera adjustable bracket may adjust the camera to an appropriate angle and height, so as to ensure the stability and real-time performance of image collection.

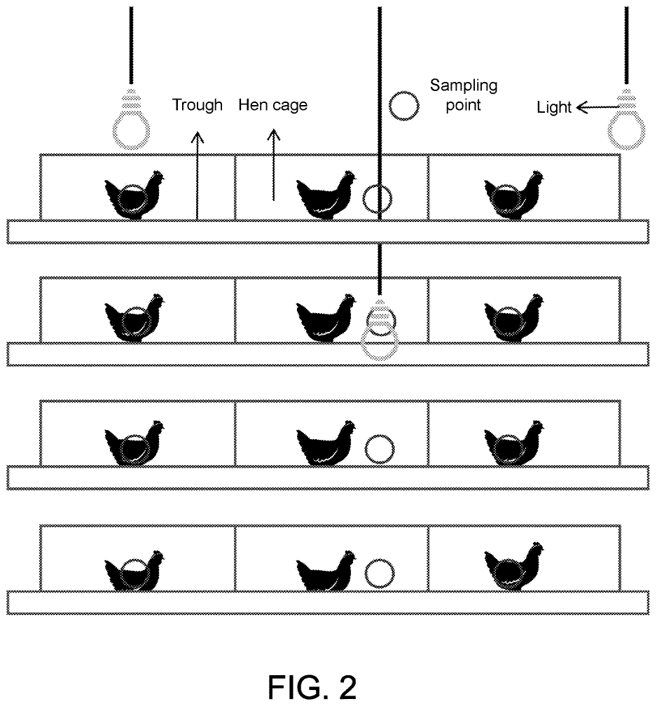

A lux meter is used together to measure the light intensity in the hen house, and auxiliary light sources are designed to ensure the stability and consistency of the image collection environment. The lux meter is used to measure the light intensity at sampling points in different positions within the hen house, including regions directly below high and low lights as well as regions between the two lights, as shown in FIG. 2. For regions with insufficient light intensity, appropriate auxiliary light sources are design and arrange, so as to ensure the stability and consistency of the image collection environment. According to the results measured by the lux meter, between the highest and lowest values of light intensity, an appropriate supplementary lighting intensity is selected, so as to ensure that the camera can obtain clear images under various lighting conditions. After the supplementary lighting intensity is determined, the auxiliary light sources are installed on the mobile chassis and ensure that the camera works in coordination with the auxiliary light sources, so as to achieve optimal image collection effects. Even in trough areas with insufficient lighting, the quality and stability of image collection can be ensured.

When trough image data is collected, the leftover feed data collection system is operated to make the leftover feed data collection system move parallel to the trough at a specified distance, and it is thus ensured that the coverage and angle of video collection meet the needs. Before videos are collected, the camera is adjusted. After the camera is initialized, the camera resolution aspect ratio is adjusted to 1920×1080 and the frame rate is adjusted to 60 FPS, so that the clarity and smoothness of the videos are ensured. To adapt to different storage and processing needs, the video encoding format is set to MP4V for subsequent video writing and processing. After camera setting is completed, collecting trough leftover feed videos is started, and stability and continuity during the collection process are required to be ensured. After videos are collected, the open-source computer vision library OpenCV is used to open the video files and read image data frame by frame from the video files. From continuous video frames, the current frame as a trough leftover feed image sample is extracted and saved every 60 frames, and high-quality trough image data is thus provided for subsequent data analysis and model training.

The data collected in step S1 is used to train a high-precision data model. This data model may analyze the relationship between feeding behavior and feed consumption and accurately estimate the leftover feed amount in the trough. Through machine learning algorithms, the model will be continuously optimized to improve the accuracy of estimation.

Step S2 specifically includes the following.
In step S2.1, the hen cage trough videos are preprocessed: first, image denoising, image contrast adjustment, and image size standardization are sequentially performed on each frame of hen cage trough pictures in the hen cage trough videos, so that the hen cage trough pictures are set to a predetermined contrast and a predetermined size to improve image quality. Cage columns around hen cages are labeled with cage column detection boxes by using a rectangular labeling tool in a picture labeling tool (labelme), so as to obtain position information of the cage columns and obtain position information of the troughs. The hen cage trough pictures are labeled by using a polygon labeling tool in the picture labeling tool, so as to segment trough regions and leftover feed regions in the hen cage trough pictures.
In step S2.2, a hen cage trough leftover feed dataset is then constructed using each frame of hen cage trough picture and corresponding label information. The label information includes cage column position information, trough region information, and leftover feed region information in the hen cage trough pictures. The rectangular cage column detection boxes are used to mark the cage column positions, the cage column detection boxes are set around the periphery of the cage columns, and the cage column position information specifically refers to the position information of the cage column detection boxes.
In step S2.3, the trough leftover feed prediction model for identifying the cage columns, the troughs, and the leftover feed regions are constructed, the trough leftover feed prediction model is trained using the hen cage trough leftover feed dataset, and the trained trough leftover feed prediction model is obtained after training is completed.
In step S2.3, the trough leftover feed prediction model includes an identification module and a segmentation model connected in sequence. In the identification module, the deep learning framework PyTorch is used to identify hen cage trough pictures. In the segmentation model, the convolutional neural network structure Yolov8n-seg is used to segment hen cage trough pictures. During the model training process, the deep learning framework PyTorch and the convolutional neural network structure Yolov8n-seg model are utilized for training, and model weights are updated through forward propagation and backward propagation to optimize model performance.

In specific implementation, first, the collected hen cage trough leftover feed dataset is split into a training set, a validation set, and a test set according to an 8:1:1 ratio to ensure the effectiveness and generalization capability of model training. In the dataset, cage columns and feed in the leftover feed regions are clearly defined as two different categories, represented by type one class0 and type two class1 for cage columns and feed respectively, so as to support the model's identification and segmentation functions. The deep learning framework PyTorch is selected, and the convolutional neural network structure Yolov8n-seg is used as the basic framework to construct the trough leftover feed prediction model. The model's training environment is arranged, and necessary dependency libraries such as cross-platform computer vision OpenCV, numerical computation extension library Numpy, plotting library matplotlib, etc., are installed, so as to support model training and validation. Model parameters are initialized, prediction outputs are calculated through forward propagation, loss functions are utilized to evaluate the difference between prediction and true labels, and model weights are updated through backward propagation. After each training epoch, the model's performance on the validation set is evaluated, early stopping strategies are implemented or model checkpoints are saved, and learning rates and hyperparameters are adjusted according to performance feedback. After training epochs are completed, the test set is used to evaluate the model's generalization capability, and necessary fine-tuning is performed. To ensure the model's performance in practical applications, the model training process is closely monitored to avoid overfitting or underfitting, and training strategies are flexibly adjusted according to training feedback.

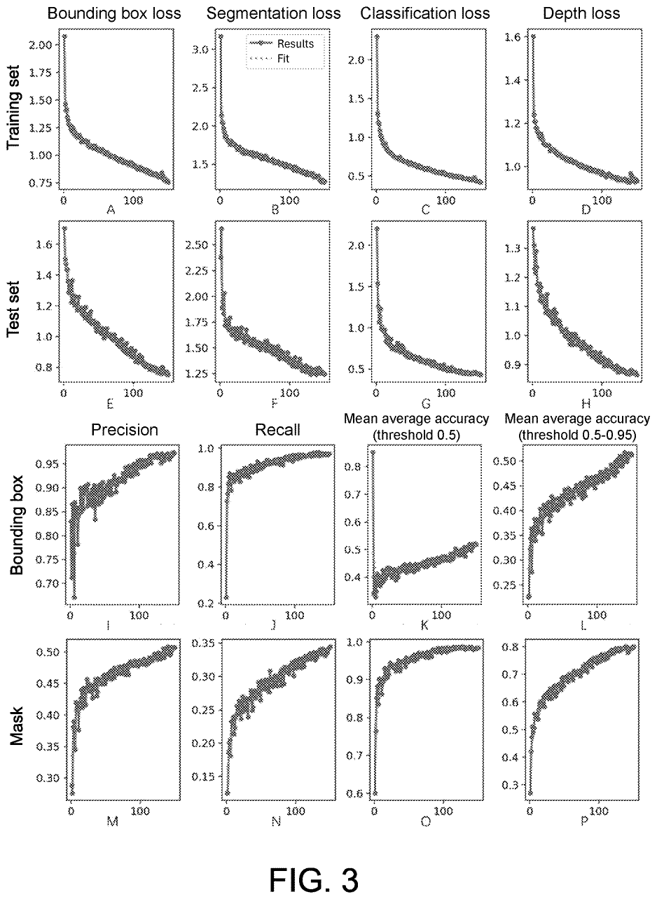

The model training results are then evaluated, including loss evaluation, precision and recall analysis, and mean average precision mAP curve plotting, so as to ensure that the model reaches the expected accuracy level. As shown in FIG. 3, the model's precision evaluation method is as follows: 1) Training and validation loss evaluation: During the model training process, key indicators of the training set train and test set including bounding box loss box_loss, segmentation loss seg_loss, classification loss cls_loss, and depth loss dfl_loss are recorded. Herein, A in FIG. 3 is the bounding box loss graph of the training set, B in FIG. 3 is the segmentation loss graph of the training set, C in FIG. 3 is the classification loss graph of the training set, D in FIG. 3 is the depth loss graph of the training set, E in FIG. 3 is the bounding box loss graph of the test set, F in FIG. 3 is the segmentation loss graph of the test set, G in FIG. 3 is the classification loss graph of the test set, and H in FIG. 3 is the depth loss graph of the test set. 2) Precision and recall analysis: The precision and recall of the bounding box and a mask on the training set and test set are evaluated, so as to measure the identification accuracy and completeness of the model. 3) Mean average precision mAP curve plotting: The mAP50 (mean average precision value with IoU threshold of 0.5) and mAP 50-95 (mean average precision with IoU threshold range from 0.5 to 0.95) curves of the model on the training set and the validation set are plotted, so as to comprehensively evaluate the model's performance under different IoU thresholds. Herein, I in FIG. 3 is the precision graph of the bounding box, J in FIG. 3 is the recall graph of the bounding box, K in FIG. 3 is the mean average accuracy graph of the bounding box (threshold is 0.5), L in FIG. 3 is the mean average accuracy graph of the bounding box (threshold is 0.5 to 0.95), M in FIG. 3 is the precision graph of the mask, N in FIG. 3 is the recall graph of the mask, O in FIG. 3 is the mean average accuracy graph of the mask (threshold is 0.5), and P in FIG. 3 is the mean average accuracy graph of the mask (threshold is 0.5 to 0.95). Preliminary performance evaluation: Through comprehensive analysis of the above indicators, preliminary evaluation of the model's identification performance is conducted, so it is ensured that the model reaches the expected precision level in hen house cage division and leftover feed segmentation tasks.

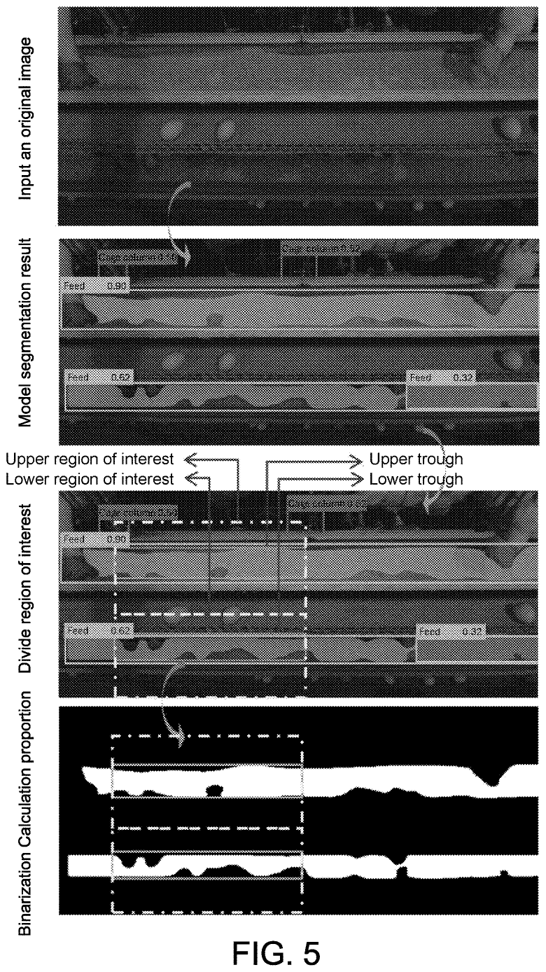

As shown in FIG. 5, step S4 specifically includes the following.
In step S4.1, first, according to input results of each frame of hen cage trough image in the hen cage trough videos, target cage columns in each frame of hen cage trough image are filtered out. The input results of each frame of hen cage trough image include the cage column positions, the trough region positions, and the leftover feed region positions output in step S3.
In step S4.2, next, according to target cage column positions, hen cages in the hen cage trough images are numbered, and a target hen cage is selected from each frame of hen cage trough image.
In step S4.3, lastly, according to the target cage column position, a region of interest is defined within the target hen cage, and the leftover feed proportion of each hen cage trough is obtained according to the region of interest.

Step S4.1 specifically includes the following.
In step S4.1.1, first, according to the cage column positions output from step S3, processing is performed according to the following formula to obtain coordinates of each cage column center point Pⱼ in each hen cage trough image:

PXⱼ=xⱼ+wⱼ/2; PYⱼ=yⱼ+hⱼ/2,

where PXⱼ and PYⱼ are respectively the horizontal and vertical coordinates of a center point Pⱼ of a j^{th} cage column from left to right in the hen cage trough image, xⱼ and yⱼ are respectively the horizontal and vertical coordinates of a top-left corner vertex of a cage column detection box corresponding to the j^{th} cage column in the hen cage trough image, and wⱼ and hⱼ are respectively a width and a height of the cage column detection box corresponding to the j^{th} cage column. Specifically, the method of the invention takes the upper left corner of the hen cage trough image as the origin to establish an XY coordinate system, where the horizontal and vertical coordinates of the coordinate system are respectively parallel to the width direction and height direction of the hen cage trough image, the positive direction of the horizontal coordinate is to the right, and the positive direction of the vertical coordinate is downward.
In steps S4.1.2, next, according to a horizontal coordinate spacing between the center points of two adjacent cage columns, reasonableness of the cage column positions is determined to obtain the target cage columns with reasonable positions. The specific method of acquiring the target cage columns is as follows.
In step S4.1.2.1, first, a first cage column in the hen cage trough image is designated as a first target cage column.
In step S 4.1.2.2, next, the number of filters Z is defined as 2.
In step S4.1.2.3, the reasonableness of a current Z^{th} cage column position is determined.

If the horizontal coordinate spacing between the center point of the current cage column and the center point of the previous target cage column adjacent to that cage column is greater than a given distance threshold Xₗᵢₘᵢₜ, it indicates that the current Z^{th} cage column is the target cage column, and the number of filters Z is incremented by 1.

Otherwise, it indicates that the current Z^{th} cage column is not the target cage column, and the number of filters Z is incremented by 1.
In step S4.1.2.4, step S4.1.2.3 is repeated until the position determination of all cage columns in the hen cage trough images is completed.

Performing reasonableness determination on the cage column positions is to exclude cage columns that have been repeatedly numbered, so as to obtain the actual positions of the cage columns.
In step S4.2.1, each hen cage in each hen cage trough video is numbered: in the hen cage trough video, each target cage column is numbered in an ascending order according to a timeline sequence, and a rectangular region between an i^{th} target cage column and an (i+1)^{th} target cage column in the hen cage trough video is then treated as an i^{th} hen cage CAᵢ of the hen cage trough video, where a height of the hen cage uses a given constant, and i represents an ordinal number of the target cage column/hen cage.
In step S4.2.2, target hen cages for leftover feed calculation are selected from each frame of hen cage trough image.

For any frame of each hen cage trough image, if the horizontal coordinate of the center point of the hen cage CAᵢ is greater than Wp/3 and less than 2Wp/3, then the hen cage CAᵢ in that frame of hen cage trough image is the target hen cage, and the leftover feed proportion calculation of the hen cage CAᵢ is performed in that frame of hen cage trough image, where Wp represents a width of the hen cage trough image.

Otherwise, the hen cage CAᵢ in that frame of hen cage trough image is not the target hen cage, and the calculation of the leftover feed proportion of the hen cage CAᵢ is not performed in the frame of hen cage trough image.

Step S4.3 specifically includes the following.
In step S4.3.1, corner points of a region of interest ROI to be defined are determined according to the target cage column position. The region of interest ROI includes a rectangular upper region of interest UROI and a rectangular lower region of interest LROI. The four corner points and corner point coordinates of the upper region of interest are upper corner point one Urec1(Xᵢ,Yᵢ), upper corner point two Urec2(Xᵢ₊₁,Yᵢ), upper corner point three Urec3(Xᵢ,3Hp/5), and upper corner point four Urec4(Xᵢ₊₁,3Hp/5). The four corner points and corner point coordinates of the lower region of interest are lower corner point one Lrec1(Xᵢ,3Hp/5), lower corner point two Lrec2(Xᵢ₊₁,3Hp/5), lower corner point three Lrec3(Xᵢ,Hp) and lower corner point four Lrec4(Xᵢ₊₁,Hp).

Herein, Xᵢ and Yᵢ are respectively the horizontal coordinate and vertical coordinate of the center point of an i^{th} target cage column from left to right in the hen cage trough image, Xᵢ₊₁ is the horizontal coordinate of the center point of an (i+1)^{th} target cage column, and Hp represents a height of the hen cage trough image.
In step S4.3.2, according to the corner point coordinates of the upper region of interest and the lower region of interest, the target hen cage of each frame of hen cage trough image is divided into the upper region of interest and the lower region of interest. The target hen cage region of each frame of hen cage trough image includes two layers of troughs, and an upper trough and a lower trough are located within the upper region of interest and the lower region of interest respectively.
In step S4.3.3, mask binarization: in the hen cage trough image, segmentation masking is performed on the leftover feed region within the target hen cage region output from step S3, so as to obtain a binary image of the leftover feed region.
In step S4.3.4, processing is performed according to the following formula to obtain a leftover feed proportion of each of the upper trough and the lower trough of each target hen cage in each frame of hen cage trough image. The leftover feed region includes the leftover feed region of the upper trough and the leftover feed region of the lower trough:

PrecisionU=MaskU/((Xᵢ₊₁−Xᵢ)(Uyu−Uyl))

PrecisionL=MaskL/((Xᵢ₊₁−Xᵢ)(Lyu−Lyl)),

where PrecisionU is the leftover feed proportion of the upper trough in the upper region of interest of the target hen cage, PrecisionL is the leftover feed proportion of the lower trough in the lower region of interest of the target hen cage, MaskU represents the number of white pixels in a binary image of an upper trough leftover feed region, MaskL represents the number of white pixels in a binary image of a lower trough leftover feed region, Uyu represents a vertical coordinate of an upper boundary line of the upper trough, Uyl represents a vertical coordinate of a lower boundary line of the upper trough, Lyu represents a vertical coordinate of an upper boundary line of the lower trough, and Lyl represents a vertical coordinate of a lower boundary line of the lower trough. The upper/lower boundary lines of the upper/lower troughs are determined according to the trough region positions.
In step S4.3.5, for the same target hen cage with the same number in all hen cage trough images, all upper trough leftover feed proportions corresponding to the same target hen cage are averaged to obtain a final upper trough leftover feed proportion of the i^{th} hen cage CAᵢ in the hen cage trough video, and all lower trough leftover feed proportions corresponding to the same target hen cage are averaged to obtain a final lower trough leftover feed proportion of the i^{th} hen cage CAᵢ in the hen cage trough video.

As shown in FIG. 1 and FIG. 2, an apparatus includes construction of the leftover feed data collection system, the trough leftover feed prediction model, and a leftover feed amount measuring system. The leftover feed data collection system including the mobile chassis, the adjustable camera bracket, and the camera is constructed. The mobile chassis is horizontally movably and is placed on the ground, the adjustable camera bracket is vertically installed on the mobile chassis, and the camera is movably installed on the adjustable camera bracket in an up-down direction. The mobile chassis and the adjustable camera bracket are configured to adjust a position and an angle of the camera. The camera is configured to collect in real time the hen cage trough videos at different heights in the battery cage-raised hen house and input the hen cage trough videos into the trained trough leftover feed prediction model. The trough leftover feed prediction model outputs the cage column positions, the trough positions, and the leftover feed region positions of various frames of hen cage trough videos in the hen cage trough videos. The leftover feed amount measuring system obtains the leftover feed proportions of the troughs in the frames of hen cage trough images in the hen cage trough videos according to the cage column positions, the trough positions, and the leftover feed region positions output by the trough leftover feed prediction model.

Finally, it is worth noting that the foregoing embodiments are merely described to illustrate the technical means of the invention and should not be construed as limitations of the invention. Even though the foregoing embodiments are referenced to provide detailed description of the invention, people having ordinary skill in the art should understand that various modifications and variations can be made to the technical means in the disclosed embodiments, or equivalent replacements may be made for part or all of the technical features; nevertheless, it is intended that the modifications, variations, and replacements shall not make the nature of the technical means to depart from the scope of the technical means of the embodiments of the invention.

What is claimed is:

1. A method for estimating leftover feed in troughs of a battery cage-raised laying hen house, comprising following steps:
step S1: constructing a leftover feed data collection system, and collecting hen cage trough videos at different heights in a battery cage-raised hen house through the leftover feed data collection system;
step S2: constructing a trough leftover feed prediction model in a computer for identifying cage columns, the troughs, and the leftover feed in the troughs, training the trough leftover feed prediction model using the hen cage trough videos, and obtaining a trained trough leftover feed prediction model after training is completed;
step S3: inputting the hen cage trough videos with a leftover feed proportion to be predicted into the trained trough leftover feed prediction model and obtaining each cage column position, each trough region position, and each leftover feed region position in the hen cage trough videos; and
step S4: according to the cage column positions, the trough region positions, and the leftover feed region positions output by the trough leftover feed prediction model in the computer, obtaining a leftover feed proportion of each trough in the hen cage trough videos.

2. The method for estimating the leftover feed in the troughs of the battery cage-raised laying hen house according to claim 1, wherein the step S1 specifically comprises:
step S1.1: constructing the leftover feed data collection system in the battery cage-raised hen house first, wherein the leftover feed data collection system mainly comprises a mobile chassis, an adjustable camera bracket, and a camera, the mobile chassis is horizontally movably and is placed on the ground, the adjustable camera bracket is vertically installed on the mobile chassis, and the camera is movably installed on the adjustable camera bracket in an up-down direction; and
step S1.2: adjusting in real time an angle and a position of the camera through the leftover feed data collection system and collecting in real time the hen cage trough videos at different heights in the battery cage-raised hen house using the camera.

3. The method for estimating the leftover feed in the troughs of the battery cage-raised laying hen house according to claim 1, wherein the step S2 specifically comprises:
step S2.1: preprocessing the hen cage trough videos: first, sequentially performing image denoising, image contrast adjustment, and image size standardization on each frame of hen cage trough picture in the hen cage trough videos, labeling the cage columns around hen cages with cage column detection boxes by using a picture labeling tool to obtain position information of the cage columns, and then labeling the hen cage trough pictures by using the picture labeling tool to label trough regions and leftover feed regions in the hen cage trough pictures;
step S2.2: then, constructing a hen cage trough leftover feed dataset using each frame of hen cage trough picture and corresponding label information, wherein the label information comprises cage column position information, trough region information, and leftover feed region information in the hen cage trough pictures; and
step S2.3: constructing the trough leftover feed prediction model for identifying the cage columns, the troughs, and the leftover feed regions, training the trough leftover feed prediction model using the hen cage trough leftover feed dataset, and obtaining the trained trough leftover feed prediction model after training is completed.

4. The method for estimating the leftover feed in the troughs of the battery cage-raised laying hen house according to claim 1, wherein the step S4 specifically comprises:
step S4.1: first, according to input results of each frame of hen cage trough image in the hen cage trough videos, filtering out target cage columns in the hen cage trough videos; the input results of each frame of hen cage trough image comprise the cage column positions, the trough region positions, and the leftover feed region positions output in step S3;
step S4.2: next, according to target cage column positions, numbering hen cages in the hen cage trough videos and selecting a target hen cage from each frame of hen cage trough image; and
step S4.3: lastly, according to the target cage column position, defining a region of interest within the target hen cage and obtaining the leftover feed proportion of each hen cage trough according to the region of interest.

5. The method for estimating the leftover feed in the troughs of the battery cage-raised laying hen house according to claim 4, wherein the step S4.1 specifically comprises:
step S4.1.1: first, according to the cage column positions output from step S3, processing according to the following formula to obtain coordinates of each cage column center point Pⱼ in each hen cage trough image:
PXⱼ=xⱼ+wⱼ/2; PYⱼ=yⱼ+hⱼ/2,
where PXⱼ and PYⱼ are respectively horizontal and vertical coordinates of a center point Pⱼ of a j^{th} cage column in the hen cage trough image; xⱼ and yⱼ are respectively the horizontal and vertical coordinates of a top-left corner vertex of a cage column detection box corresponding to the j^{th} cage column; wⱼ and hⱼ are respectively a width and a height of the cage column detection box corresponding to the j^{th} cage column, where j represents an ordinal number of the cage column;
steps S4.1.2: next, according to a horizontal coordinate spacing between the center points of two adjacent cage columns, determining reasonableness of the cage column positions to obtain the target cage columns with reasonable positions, wherein a specific method of acquiring the target cage columns is:
step S4.1.2.1: first, designating a first cage column in the hen cage trough image as a first target cage column;
step S 4.1.2.2: next, defining the number of filters Z as 2;
step S4.1.2.3, determining the reasonableness of a current Z^{th} cage column position:
if the horizontal coordinate spacing between the center point of the current cage column and the center point of the previous target cage column is greater than a distance threshold Xₗᵢₘᵢₜ, it indicates that the current Z^{th} cage column is the target cage column, and the number of filters Z is incremented by 1;
otherwise, it indicates that the current Z^{th} cage column is not the target cage column, and the number of filters Z is incremented by 1; and
step S4.1.2.4: repeating step S4.1.2.3 until the position determination of all cage columns is completed.

6. The method for estimating the leftover feed in the troughs of the battery cage-raised laying hen house according to claim 4, wherein the step S4.2 specifically comprises:
step S4.2.1, numbering each hen cage in each hen cage trough video: in the hen cage trough video, numbering each target cage column in an ascending order according to a timeline sequence, then treating a rectangular region between an i^{th} target cage column and an (i+1)^{th} target cage column in the hen cage trough video as an i^{th} hen cage CAᵢ of the hen cage trough video, where a height of the hen cage uses a given constant, and i represents an ordinal number of the target cage column/hen cage; and
step S4.2.2: selecting target hen cages for leftover feed calculation from each frame of hen cage trough image:
for any frame of hen cage trough image, if the horizontal coordinate of the center point of the hen cage CAᵢ is greater than Wp/3 and less than 2Wp/3, then the hen cage CAᵢ in that frame of hen cage trough image is the target hen cage, where Wp represents a width of the hen cage trough image;
otherwise, the hen cage CAᵢ in the hen cage trough image of that frame is not the target hen cage.

7. The method for estimating the leftover feed in the troughs of the battery cage-raised laying hen house according to claim 4, wherein the step S4.3 specifically comprises:
step S4.3.1, determining corner points of a region of interest ROI to be defined according to the target cage column position, the region of interest ROI comprises a rectangular upper region of interest UROI and a rectangular lower region of interest LROI, the four corner points and corner point coordinates of the upper region of interest are upper corner point one Urec1(Xᵢ,Yᵢ), upper corner point two Urec2(Xᵢ₊₁,Yᵢ), upper corner point three Urec3(Xᵢ,3Hp/5), and upper corner point four Urec4(Xᵢ₊₁,3Hp/5), the four corner points and corner point coordinates of the lower region of interest are lower corner point one Lrec1(Xᵢ,3Hp/5), lower corner point two Lrec2(Xᵢ₊₁,3Hp/5), lower corner point three Lrec3(Xᵢ,Hp) and lower corner point four Lrec4(Xᵢ₊₁,Hp);
where Xᵢ and Yᵢ are respectively the horizontal coordinate and vertical coordinate of the center point of an i^{th} target cage column in the hen cage trough image; Xᵢ₊₁ is the horizontal coordinate of the center point of an (i+1)^{th} target cage column; Hp represents a height of the hen cage trough image;
step S4.3.2: according to the corner point coordinates of the upper region of interest and the lower region of interest, dividing the target hen cage of each frame of hen cage trough image into the upper region of interest and the lower region of interest, the target hen cage region of each frame of hen cage trough image comprises two layers of troughs, and an upper trough and a lower trough are located within the upper region of interest and the lower region of interest respectively;
step S4.3.3: in the hen cage trough image, performing segmentation masking on the leftover feed region within the target hen cage region to obtain a binary image of the leftover feed region;
step S4.3.4: processing according to following formula to obtain a leftover feed proportion of each of the upper trough and the lower trough of each target hen cage in each frame of hen cage trough image:
PrecisionU=MaskU/((Xᵢ₊₁−Xᵢ)(Uyu−Uyl))
PrecisionL=MaskL/((Xᵢ₊₁−Xᵢ)(Lyu−Lyl)),
where PrecisionU is the leftover feed proportion of the upper trough in the upper region of interest of the target hen cage; PrecisionL is the leftover feed proportion of the lower trough in the lower region of interest of the target hen cage; MaskU represents the number of white pixels in a binary image of an upper trough leftover feed region; MaskL represents the number of white pixels in a binary image of a lower trough leftover feed region; Uyu represents a vertical coordinate of an upper boundary line of the upper trough; Uyl represents a vertical coordinate of a lower boundary line of the upper trough; Lyu represents a vertical coordinate of an upper boundary line of the lower trough; Lyl represents a vertical coordinate of a lower boundary line of the lower trough; and
step S4.3.5: for the same target hen cage with the same number in all hen cage trough images, averaging all upper trough leftover feed proportions corresponding to the same target hen cage to obtain a final upper trough leftover feed proportion of the i^{th} hen cage CAᵢ in the hen cage trough video, and averaging all lower trough leftover feed proportions corresponding to the same target hen cage to obtain a final lower trough leftover feed proportion of the i^{th} hen cage CAᵢ in the hen cage trough video.

8. An apparatus for implementing the method according to claim 1,
comprising construction of the leftover feed data collection system, the trough leftover feed prediction model, and a leftover feed amount measuring system, wherein the leftover feed data collection system comprising a mobile chassis, an adjustable camera bracket, and a camera, the mobile chassis is horizontally movably and is placed on the ground, the adjustable camera bracket is vertically installed on the mobile chassis, the camera is movably installed on the adjustable camera bracket in an up-down direction, the mobile chassis and the adjustable camera bracket are configured to adjust a position and an angle of the camera, the camera is configured to collect in real time the hen cage trough videos at different heights in the battery cage-raised hen house and input the hen cage trough videos into the trained trough leftover feed prediction model, the trough leftover feed prediction model outputs the cage column positions, the trough positions, and the leftover feed region positions of various frames of hen cage trough videos in the hen cage trough videos, and the leftover feed amount measuring system obtains the leftover feed proportions of the troughs in the frames of hen cage trough images according to the cage column positions, the trough positions, and the leftover feed region positions output by the trough leftover feed prediction model.

9. A computer apparatus, comprising a memory and a processor, the memory storing a computer program, wherein the processor implements the steps of the method according to claim 1 when executing the computer program.

10. A computer-readable storage medium having a computer program stored thereon, wherein when the computer program is executed by a processor, the steps of the method according to claim 1 are implemented.
